(19) United States
(12) Patent Application Publication
(10) Pub. No.: US 2014/0355658 A1
(43) Pub. Date: Dec. 4, 2014

(54) Modal PAM2/PAM4 Divide By N (Div-N) Automatic Correlation Engine (ACE) For A Receiver

(71) Applicant: Avago Technologies General IP (Singapore) Pte. Ltd., Singapore (SG)

(72) Inventors: Peter J. Meier, Fort Collins, CO (US); Jeffrey A. Slavick, Fort Collins, CO (US); Jade Michael Kizer, Windsor, CO (US); Darrin C. Miller, Fort Collins, CO (US)

(21) Appl. No.: 13/905,936

(22) Filed: May 30, 2013

(51) Int. Cl. H04L 1/24; H04L 27/06

(52) U.S. Cl. CPC H04L 1/245; H04L 27/06
USPC 375/224

(57) ABSTRACT

A correlation engine includes a first register configured to receive a test data signal, a second register configured to receive a main data signal, first shift logic configured to shift the test data signal by a predetermined value between 0 and 3 symbols, second shift logic configured to shift the main data signal by a predetermined value between 0 and 20 symbols, and comparison logic configured to compare the shifted test data signal and the shifted main data signal to generate an error signal.

### BACKGROUND

A modern integrated circuit (IC) must meet very stringent design and performance specifications. In many applications for communication devices, transmit and receive signals are exchanged over communication channels. These communication channels include impairments that affect the quality of the signal that traverses them. One type of IC that uses both a transmit element and a receive element is referred to as a serializer/deserializer (SERDES). The transmit element on a SERDES typically sends information to a receiver on a different SERDES over a communication channel. The communication channel is typically located on a different structure from where the SERDES is located. To correct for impairments introduced by the communication channel, a transmitter and/or a receiver on a SERDES or other IC may include circuitry that performs channel equalization and other methods of validating the received data. One of the methods for validating the received data refers to a correlation methodology that compares portions of the received data with a test sequence. The test sequence can be a pseudorandom binary sequence (PRBS) pattern, or another type of sequence. Often, the received data must be aligned with the test pattern before a comparison can be made.

Some of the challenges with correlating the received data become more challenging when attempting to design and fabricate a receiver that can operate using both PAM 2 and PAM 4 modalities. The acronym PAM refers to pulse amplitude modulation, which is a form of signal modulation where the message information is encoded into the amplitude of a series of signal pulses. PAM is an analog pulse modulation scheme in which the amplitude of a train of carrier pulses is varied according to the sample value of the message signal. A PAM 2 communication modality refers to a modulator that takes one bit at a time and maps the signal amplitude to one of two possible levels (two symbols), for example −1 volt and 1 volt. A PAM 4 communication modality refers to a modulator that takes two bits at a time and maps the signal amplitude to one of four possible levels (four symbols), for example −3 volts, −1 volt, 1 volt, and 3 volts. For a given baud rate, PAM 4 modulation can transmit up to twice the number of bits as PAM 2 modulation.

Therefore, it would be desirable to have a way to implement a correlation engine in a receiver that is useful for both PAM 2 and PAM 4 modalities.

### SUMMARY

In an embodiment, a correlation engine comprises a first register configured to receive a test data signal, a second register configured to receive a main data signal, first shift logic configured to shift the test data signal by a predetermined value between 0 and 3 symbols, second shift logic configured to shift the main data signal by a predetermined value between 0 and 20 symbols, and comparison logic configured to compare the shifted test data signal and the shifted main data signal to generate an error signal.

Other embodiments are also provided. Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view illustrating an example of a communication system in which the modal PAM 2/PAM 4 divide by n (div-n) automatic correlation engine (ACE) can be implemented.

FIG. 2 is a schematic diagram illustrating an example receiver of FIG. 1.

FIG. 3 is a schematic diagram illustrating an instance of the automatic correlation engine (ACE) of FIG. 2.

FIG. 4 is a block diagram illustrating a unit cell showing the masking operation performed by the qualification data path shown in FIG. 3.

FIGS. 5A and 5B are examples of the expansion logic of FIG. 4.

### DETAILED DESCRIPTION

A modal PAM 2/PAM 4 divide by n (div-n) automatic correlation engine (ACE) for a receiver can be implemented in any integrated circuit (IC) that uses a digital direct conversion receiver (DCR) to receive a communication signal over a communication channel. In an embodiment, the modal PAM 2/PAM 4 divide by n automatic correlation engine for a receiver is implemented in a serializer/deserializer (SERDES) receiver operating at a 50 gigabit per second (Gbps) data rate by implementing a pulse amplitude modulation (PAM) 4 modulation methodology operating at 25 GBaud (Gsymbols per second). The 50 Gbps data rate is enabled, at least in part, by the pipelined implementation to be described below, and is backward compatible with PAM 2 modulation methodologies operating at a data rate of 25 Gbps. For PAM 2, one symbol comprises one (1) bit, for PAM 4, one symbol comprises two (2) bits.

As used herein, the term “cursor” refers to a subject bit, the term “precursor” or “pre” refers to a bit that precedes the “cursor” bit and the term “post-cursor” or “post” refers to a bit that is subsequent to the “cursor” bit.

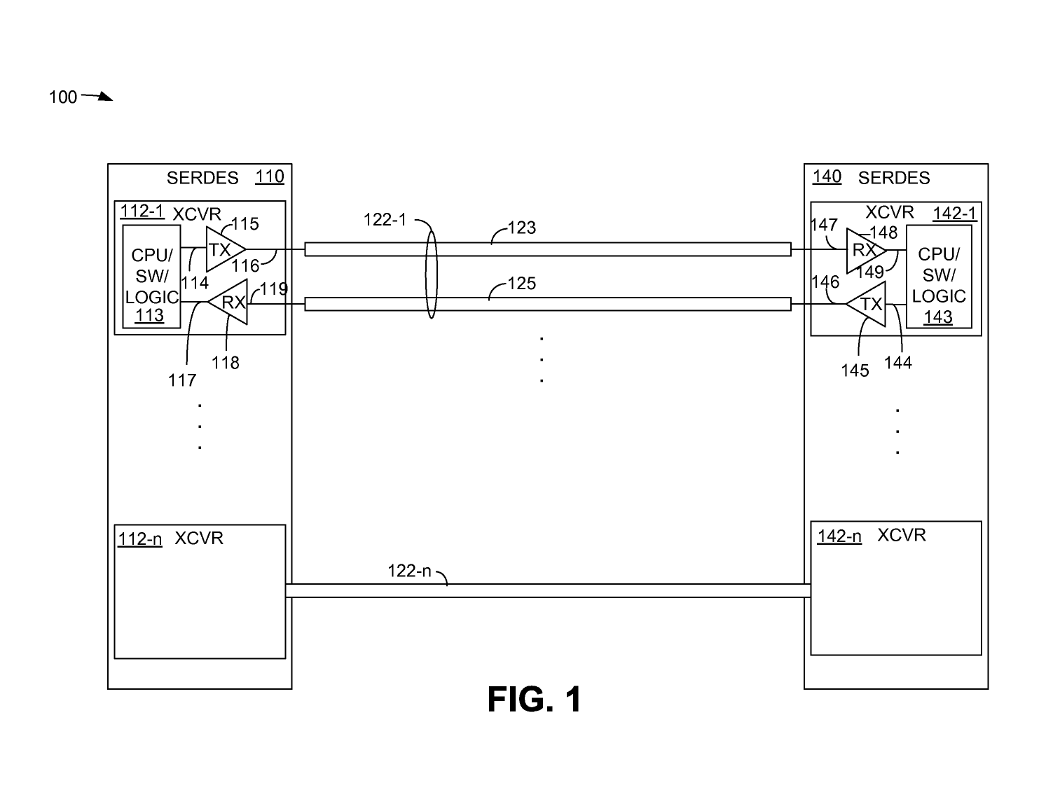

FIG. 1 is a schematic view illustrating an example of a communication system 100 in which the modal PAM 2/PAM 4 divide by n (div-n) automatic correlation engine (ACE) can be implemented. The communication system 100 is an example only of one possible implementation. The communication system 100 comprises a serializer/deserializer (SERDES) 110 that includes a plurality of transceivers 112. Only one transceiver 112-1 is illustrated in detail, but it is understood that many transceivers 112-n can be included in the SERDES 110.

The transceiver 112-1 comprises logic 113, which includes the functionality of a central processor unit (CPU), software (SW) and general logic, and will be referred to as “logic” for simplicity. It should be noted that the depiction of the transceiver 112-1 is highly simplified and intended to merely illustrate the basic components of a SERDES transceiver.

The transceiver 112-1 also comprises a transmitter 115 and a receiver 118. The transmitter 115 receives an information signal from the logic 113 over connection 114 and provides a transmit signal over connection 116. The receiver 118 receives an information signal over connection 119 and provides a processed information signal over connection 117 to the logic 113.

The system 100 also comprises a SERDES 140 that includes a plurality of transceivers 142. Only one transceiver 142-1 is illustrated in detail, but it is understood that many transceivers 142-n can be included in the SERDES 140.

The transceiver 142-1 comprises a logic element 143, which includes the functionality of a central processor unit (CPU), software (SW) and general logic, and will be referred to as “logic” for simplicity. It should be noted that the depiction of the transceiver 142-1 is highly simplified and intended to merely illustrate the basic components of a SERDES transceiver.

The transceiver 142-1 also comprises a transmitter 145 and a receiver 148. The transmitter 145 receives an information signal from the logic 143 over connection 144 and provides a transmit signal over connection 146. The receiver 148 receives an information signal over connection 147 and provides a processed information signal over connection 149 to the logic 143.

The transceiver 112-1 is connected to the transceiver 142-1 over a communication channel 122-1. A similar communication channel 122-n connects the “n” transceivers 112-n to corresponding “n” transceivers 142-n.

In an embodiment, the communication channel 122-1 can comprise communication paths 123 and 125. The communication path 123 can connect the transmitter 115 to the receiver 148 and the communication path 125 can connect the transmitter 145 to the receiver 118. The communication channel 122-1 can be adapted to a variety of communication methodologies including, but not limited to, single-ended, differential, or others, and can also be adapted to carry a variety of modulation methodologies including, for example, PAM 2, PAM 4 and others. In an embodiment, the receivers and transmitters operate on differential signals. Differential signals are those that are represented by two complementary signals on different conductors, with the term “differential” representing the difference between the two complementary signals. The two complementary signals can be referred to as the “true” or “t” signal and the “complement” or “c” signal. All differential signals also have what is referred to as a “common mode,” which represents the average of the two differential signals. High-speed differential signaling offers many advantages, such as low noise and low power while providing a robust and high-speed data transmission.

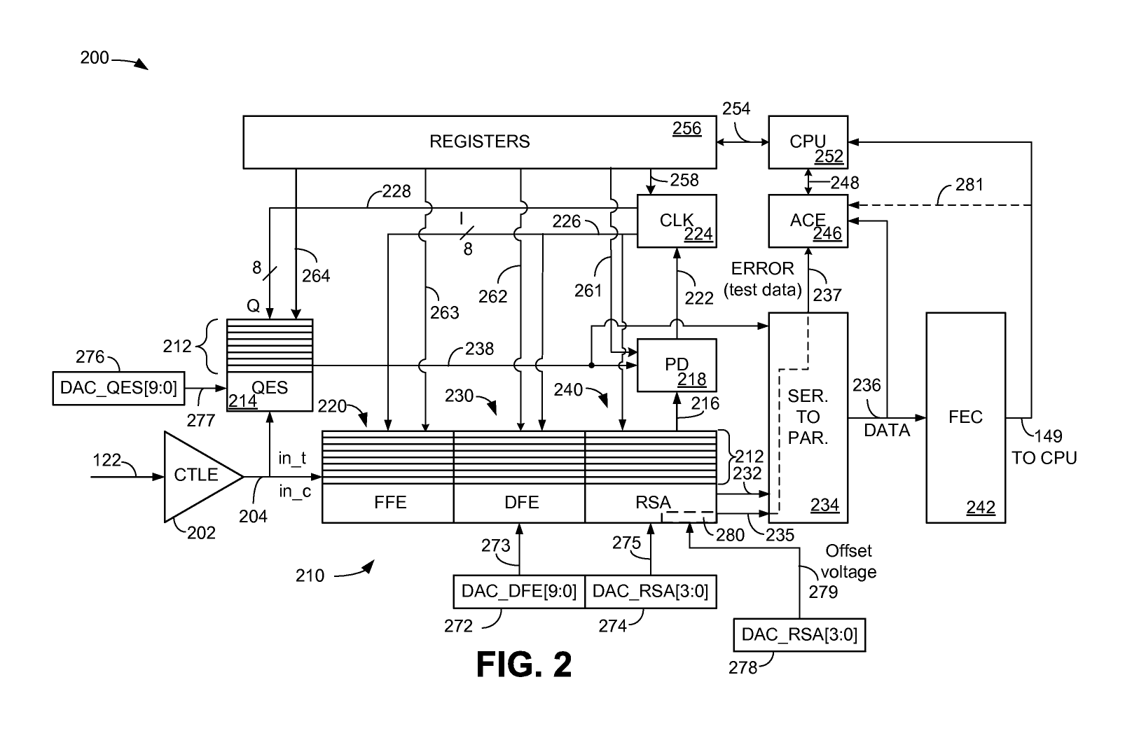

FIG. 2 is a schematic diagram illustrating an example receiver of FIG. 1. The receiver 200 can be any of the receivers illustrated in FIG. 1. The receiver 200 comprises a continuous time linear equalizer (CTLE) that receives the information signal from the communication channel 122 (FIG. 1). The output of the CTLE 202 is provided to a quadrature edge selection (QES) element 214 and to a pipelined processing system 210. The pipelined processing system 210 comprises a pipelined feed forward equalizer (FFE) 220, a pipelined decision feedback equalizer (DFE) 230 and a regenerative sense amplifier (RSA) 240.

In this embodiment of the receiver 200, the reference to a “pipelined” processing methodology refers to the ability of the FFE 220, the DFE 230 and the RSA 240 to process eight (8) pipelined stages 212 simultaneously. In this embodiment, a “div-n” automatic correlation engine is implemented where “n” equals 8, and refers to the ability to simultaneously process the 8 pipelined stages 212.

The DFE 230 receives a threshold voltage input from a digital-to-analog converter (DAC) 272 over connection 273. The RSA 240 receives a threshold voltage input from a digital-to-analog converter (DAC) 274 over connection 275. The DAC 272 and the DAC 274 can be any type of DAC that can supply a threshold voltage input based on system requirements.

The RSA 240 converts an analog voltage into a complementary metal oxide semiconductor (CMOS) voltage. The output of the RSA 240 comprises sampled data/edge information and is provided over connection 216 to a phase detector (PD) 218. The output of the phase detector 218 comprises an update signal having, for example, an up/down command, and is provided over connection 222 to a clock (CLK) element 224. The clock element 224 provides an in-phase (I) clocking signal over connection 226 and provides a quadrature (Q) clocking signal over connection 228. The in-phase (I) clocking signal is provided to the pipelined FFE 220, the DFE 230, and to the RSA 240; and the quadrature (Q) clocking signal is provided to the QES element 214.

The QES element 214 receives a threshold voltage input from a DAC 276 over connection 277. The DAC 276 can be any type of DAC that can supply a threshold voltage input based on system requirements.

The data output of the RSA 240 on connection 232 is a digital representation of the raw, high speed signal prior to any line coding, forward error correction, or demodulation to recover data. In the case of PAM2, the output symbols are a sequence of ones and zeros. In the case of PAM N, it is a sequence of N binary encoded symbols. For example, for PAM 4, the output comprises a string composed of four distinct symbols, each identified by two complementary metal-oxide semiconductor (CMOS) binary values representing the four possible symbols. The data output of the RSA 240 is provided over connection 232 to a serial-to-parallel converter 234. The serial-to-parallel converter 234 converts the high speed digital data stream on connection 232 to a lower speed bus of parallel data on connection 236. The output of the serial-to-parallel converter 234 on connection 236 is the parallel data signal and is provided to a forward error correction (FEC) element 242.

In an embodiment, the RSA 240 also comprises a test RSA 280. The test RSA 280 can be implemented in parallel with the normal data processing in the RSA 240. The test RSA 280 receives an offset voltage from a test DAC_RSA 278 over connection 279. The test RSA 280 provides a test signal over connection 235 to a serial-to-parallel converter 234. The test RSA 280 receives a different offset value than the data RSA 240, which makes the test RSA 280 more prone to errors, i.e., the test RSA 280 requires greater margin in the incoming data to provide correct data. Using a PAM 2 system example where the input signal is transitioning from +1V to −1V, if the offset voltage on the test RSA 280 is set to 0V, then there is a +/−1 Volt noise/signal margin. Therefore, if the input voltage is degraded to only +0.5V, with −0.3V of noise, the test RSA 280 will still have 0.2V at the input and will resolve properly to a one. However, if a 0.25V offset is introduced on the test RSA 280, then this signal will appear negative and will incorrectly resolve to a zero. So, introducing this offset voltage from the DAC_RSA 278 to the test RSA 280 produces a higher level of errors which enables the receiver 200 to be tuned with normal data patterns by comparing the differences between the test data and the normal data. Any differences between the two streams of data will denote data that has less margin than the additional offset introduced into the test RSA 280.

The serial-to-parallel converter 234 converts (also referred to as “decelerates”) the test signal on connection 235 to parallel data and provides a test signal over connection 237. The output of the serial-to-parallel converter 234 on connection 237 is provided to an automatic correlation engine (ACE) 246. This occurs in parallel with the deceleration of the normal (or main) data channel, which can be provided to the ACE 246 over connection 236. The automatic correlation engine (ACE) 246 operates on 20 symbols at a time, which is the decelerated data rate at the output of the serial-to-parallel converter 234. The main data on connection 236 and the test data on connection 237 comprise 20 bit long words for PAM 2 and 40 bit long words for PAM 4. The ACE 246 should understand the relationship between the 8 pipeline stages and the data it is processing, hence the use of, for example, of a 40 bit mask value. The operation of the automatic correlation engine (ACE) 246 will be described below.

In an alternative embodiment the data from the output of the FEC 242 can be provided to the ACE 246 over connection 281, which is shown as a dotted line to indicate that it is optional. However, if the data from the output of the FEC 242 is provided to the ACE 246, due to additional delays introduced into the data due to the FEC logic, additional delays will be added to the test data on connection 237 to match the delays of the FEC 242. These delays added to the test data on connection 237 can be based upon the number of clocked states in the FEC 242, so that the additional delay on connection 237 can be implemented by a FIFO (First In First Out) register file (not shown). The output of the FEC 242 is provided over connection 149 to the CPU 252.

The output of the ACE 246 is provided over connection 248 to the CPU 252. The implementation of the ACE 246 could be done with hardware on chip, firmware off chip, or a combination of hardware and firmware, and a CPU, in which case the CPU 252 would read and write to the ACE 246 over connection 248. The ACE 246 compares the received main data to test data or to a pseudorandom binary sequence (PRBS) pattern and provides a correlation function to support implementation of a least mean square (LMS) algorithm for tuning the receiver 200.

The CPU 252 is connected over a bi-directional link 254 to the registers 256. The registers 256 store DFE filter coefficients, FFE controls, CTLE controls, RSA threshold voltage controls, offset correction values for the RSA and QES elements, and controls for the DACs.

An output of the registers 256 on connection 261 is provided to the phase detector 218; an output of the registers 256 on connection 262 is provided to the pipelined DFE 230; an output of the registers 256 on connection 263 is provided to the pipelined FFE 220; and an output of the registers 256 on connection 264 is provided to the QES element 214. The output of the QES element 214 on connection 238 comprises sampled data/edge information and is provided to the phase detector 218 and the serial-to-parallel converter 234.

The elements in FIG. 2 generally operate based on a system clock signal that runs at a particular frequency, which corresponds to the baud rate of the data channel. A time period, referred to as a unit interval (UI) generally corresponds to a time period of one clock cycle of the system clock for a non-pipelined system. For a pipelined system, a transceiver could be communicating at 50 Gbps, using PAM4, the baud rate is 25 G baud per second, and one UI would be 40 ps=1/25 G.

Generally, a receive signal on connection 204 is applied to an array of FFE/DFE/RSA/QES sections. If an array of N sections is implemented, then each section can process the receive signal at a rate of 1/(UI*N) which significantly relaxes power requirements compared to the standard (un-pipelined) processing.

For example, a 25 Gbaud receive signal could be processed by an array of 8 sections, each section running at 3.125 GHz. The start time for each section is offset by 1 UI from its neighboring section, so that when the outputs from all 8 sections are summed together (signal 236), it is updated at the original 25 Gbaud rate.

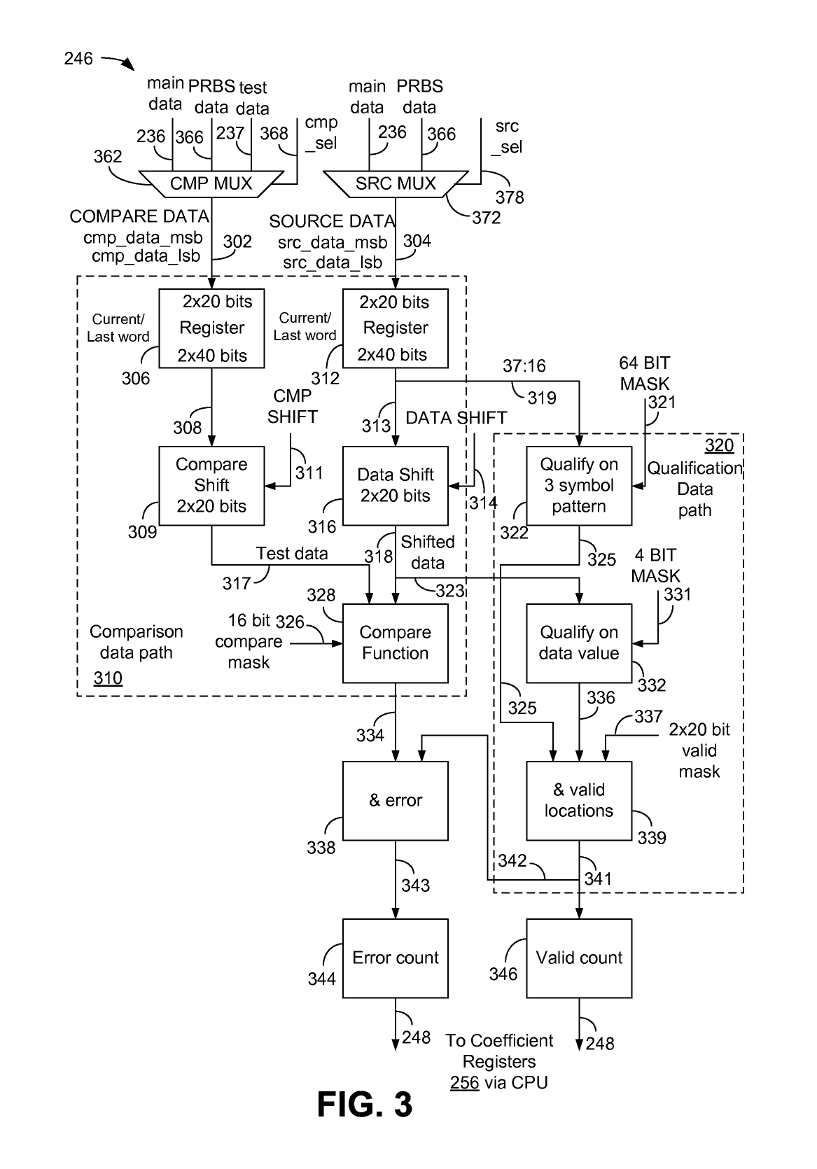

FIG. 3 is a schematic diagram illustrating an embodiment of the automatic correlation engine (ACE) 246 of FIG. 2. For PAM 2, one symbol comprises one (1) bit; and for PAM 4, one symbol comprises two (2) bits.

When implemented as part of the receiver 200 as shown in FIG. 2, the ACE 246 compares the received data to the test data or to a pseudorandom binary sequence (PRBS) pattern and provides a correlation function to support implementation of a least mean square (LMS) algorithm for tuning the receiver. The implementation of the ACE 246 shown in FIG. 3 generally comprises a comparison data path 310 and a qualification data path 320. The comparison data path 310 and the qualification data path 320 will be described in greater detail below.

A multiplexer 362, referred to as a “compare” or “cmp” multiplexer (cmp_mux), receives the main data signal over connection 236, receives the test data signal over connection 237, receives PRBS data over connection 366 and receives a compare select control signal “cmp_sel” over connection 368. A multiplexer 372, referred to as a “source” or “src” multiplexer (src_mux), receives the main data signal over connection 236, receives the PRBS data over connection 366 and receives a source select control signal “src_sel” over connection 378.

The comparisons can be performed in two modes. In a first mode, if the transmitted data is sent as a known PRBS pattern, then the PRBS pattern can be used to seed a PRBS pattern in the receiver (only a certain number of correct bits are needed to seed the new pattern, such as the number of bits in the PRBS pattern). This PRBS pattern generated in the receiver can be used as a known good pattern, and can detect errors in the actual data stream. This known PRBS pattern can also be compared against the degraded test channel (to be described below) as well. However, in many cases, only normal data (the main data on connection 236, FIG. 2) is available in the receiver 200 where the normal data is not known a priori. In this second mode, the test channel is used with a degraded margin (either in time, phase or both) to create a lack of margin and this test data is compared against the main data, assuming that the main data is correct, not that there might not be some errors. It is also possible to compare the main data after the FEC 242 (FIG. 2) against the test data, as described above.

In an embodiment, the control signal cmp_sel on connection 368 causes the cmp_mux 362 to select the test data signal on connection 237 and passes this signal to the comparison data path 310 over connection 302. In an embodiment, the control signal src_sel on connection 378 causes the src_mux 372 to select the main data signal on connection 236 and passes this signal to the comparison data path 310 over connection 304.

An example of the operation of the ACE 246 includes example symbol (or bit) values as follows. Note that in the following example, the first number, in parenthesis, is the state time for the data, the second number is the value of the symbols (or bits) at that time, and the third number, in parenthesis, corresponds to the reference number of the corresponding elements or connections in FIG. 3.

In this example, the main data signal on connection 236 and the test data on connection 237 can be defined as follows:

(1) 11021001001333222030 (236)
(2) 10223301131211012310 (236)
(3) 20130213321132120103 (236)
(1) 00020101112322223130 (237)
(2) 01222201021200013210 (237)
(3) 31131313231123121003 (237)

In this example, the PRBS data on connection 366 does not affect the operation of this system.

In this example, the operation of the cmp_mux 362 is defined by:

if (368)==00, then (302)=(236);
if (368)==01, then (302)=(366);
if (368)==10, then (302)=(237).

In this example, the cmp_sel signal on connection 368 is set to 10, so the value of the signal on connection 302=the test data signal on connection 237.

The value of the signal on connection 302 is given by:

(1) 00020101112322223130 (302);
(2) 01222201021200013210 (302);
(3) 31131313231123121003 (302).

In this example, the operation of the src_mux 372 is defined by:

if (378)==0, then (304)=(236);
if (378)==1, then (304)=(366).

In this example, the src_sel signal on connection 378 is set to 0, so the value of the signal on connection 304=the main data signal on connection 236.

The value of the signal on connection 304 is given by:

(1) 11021001001333222030 (304);
(2) 10223301131211012310 (304);
(3) 20130213321132120103 (304).

The ACE 246 comprises a number of registers and functional blocks that are described below. There are two sets of inputs to the ACE 246. A first input is referred to as the “compare data” input and is provided as the test signal from the serial-to-parallel converter 234 (FIG. 2) over connection 237, as described above. A second input is referred to as the “source data” input and is provided as the received main data from the serial-to-parallel converter 234 (FIG. 2) over connection 236. The compare data is provided to the register block 306 and the source data is provided to the register block 312. The register blocks 306 and 312, and the other register blocks to be described below, may have any of a variety of configurations.

The compare data is either the pattern against which the data is checked, such as a PRBS pattern, or the test data signal from the serial-to-parallel converter 234. The source data is typically the recovered main channel data.

The comparison data path 310 generally comprises an operational aspect including a compare function where the compare data and the source data are properly aligned and compared against each other. This allows the user to determine if there are PRBS or other pattern errors in the source data. Another operational aspect of the comparison data path 310 is to enable LMS tuning algorithms. To implement an LMS tuning algorithm, it is desirable to find correlations between an error term at a specific point in time to a data term that occurred at an arbitrary point in time (that could be similar or different to the error time). The ACE 246 can be implemented to cover a range of from 3 pre cursors to 17 post cursors. The ACE 246 determines a valid sequence that will lead up to the correlation, which is selected by the symbol pattern. Then, the ACE 246 selects an appropriate compare shift and data shift to properly align these symbols in relation to each other. At that time, the appropriate data patterns and the appropriate masks are selected to check. The compare function can be set for the specific type of comparison The compare function can provide any of the 65536 (2̂16) possible logical functions for the four possible inputs, 2 bits from the test channel against 2 bits from data channel. This allows for simple comparisons (exclusive OR) functions on either or both bits, as well as any other logical function. The ACE 246 will keep track of the number of valid compare points as well as the number of points that met the condition based on the compare function.

The qualification data path 320 comprises an operational aspect where valid compare points are selected based on a set of criteria based upon the source data and a valid mask.

The first stage of the comparison data path 310 comprises the register blocks 306 and 312, which each receive the current two sets of 20 bits, the most significant bit (MSB) bit and least significant bit (LSB) of data along with the previous sets of MSB and LSB data bits and store them in two 40 bit registers (for a total of four 40 bit registers). The MSB of the compare data is referred to as “cmp_data_msb” and the LSB of the compare data is referred to as “cmp_data_lsb.” The MSB of the source data is referred to as “src_data_msb” and the LSB of the source data is referred to as “src_data_lsb.” The MSB and LSB together define the symbol. This provides a wide compare word to allow for correlations separated by up to 17 bits for post cursor analysis and three (3) bits of pre cursor analysis, thus providing a 20 symbol range over which the main data can be shifted. One cursor position equates to one unit interval (UI) of the system clock cycle.

The register block 306 contains the pattern from the previous state of the connection 302 on the first 20 symbols combined with the pattern from two states prior on connection 302 on the last 20 symbols as follows:

(3) 0122220102120001321000020101112322223130 (308);
(4) 3113131323112312100301222201021200013210 (308).

The register block 312 contains the pattern from the previous state of the connection 304 on the first 20 symbols combined with the pattern from two states prior on connection 304 on the last 20 symbols as follows:

(3) 1022330113121101231011021001001333222030 (313);
(4) 2013021332113212010310223301131211012310 (313).

The next stage of the comparison data path 310 comprises a pair of shift circuits. A compare shift circuit 309 receives the compare data over connection 308 and a “compare shift” control signal over connection 311. The “compare shift” control signal on connection 311 is a programmable value.

The compare shift circuit 309 is defined by a shift operation that will shift the data on connection 308 to the right by the number of symbols (from 0-3 symbols) defined by the control signal on connection 311. If the control signal on connection 311 is set to 2, then the output of compare shift circuit 309 will align to the output of the processing element 322 (to be described below) such that the qualification will be based upon 2 precursors and the cursor of the data. If the control signal on connection 311 is set to 1, then the output of compare shift circuit 309 will align to the output of processing element 322 such that the qualification will be based upon 1 precursor, the cursor, and 1 post cursor. If the control signal on connection 311 is set to 0, then the output of compare shift circuit 309 will align to the output of processing element 322 such that the qualification will be based upon the cursor and 2 post cursors. The compare shift circuit 309 is defined as the input on connection 308 shifted right by 16 symbols plus the value of the control signal on connection 311, and limiting the output on connection 317 to the rightmost 20 symbols.

For this example, the control signal on connection 311 is set to 2, so:

(3) 22220102120001321000 (317);
(4) 13131323112312100301 (317).

A data shift circuit 316 receives the source data over connection 313 and a “data shift” control signal over connection 314. The “data shift” control signal on connection 314 is a programmable value. The offset of the data in the compare shift circuit 309 and the data shift circuit 316 can be shifted by 0-20 symbols to align the data to an appropriate bit in the symbol pattern (first, second or third) in case the compare data and the source data are offset from each other. The compare data and the source data can be shifted to provide the proper offset between the test channel (the compare data) and the data channel (the source data) to determine if there is a desired offset.

For shift values of 0 to 2 symbols for the source data shift in the circuit 316, the low symbols are extended range values. These values are the last three symbols that have been selected using the extended symbol select. This function is provided to enable longer correlations for floating taps. The extended symbols allow for data to be held beyond 20 symbols. There is a symbol selected out of the 20 symbols that is held in an additional 3 symbol register. Therefore, in addition to having the symbols 19:0 available, the ACE 246 also has symbols 20+offset, 40+offset and 60+offset available, where the offsets can be provided on the control line 314. This larger offset symbol can allow for tuning taps past 20, which is used for a floating tap receiver. A floating tap is a tap that can be placed anywhere within a larger range, allowing for correcting specific issues that arise due to signal reflections in the system.

The data shift circuit 316 is defined by shifting the data on connection 313 right by the value of the control signal on connection 314 minus 3 symbols, and limiting the output on connection 318 to the rightmost 20 symbols.

For this example, the control signal on connection 314 is set to 17 to shift right by 14 symbols, so:

(3) 01131211012310110210 (318);
(4) 13321132120103102233 (318).

Because the data on connection 317 is shifted by 18 symbols, and the data on connection 318 is shifted by 14 symbols, there is a 4 symbol difference between the relative times of the symbols to each other. This 4 symbol time difference allows the receiver 200 to collect error data from the test data as the forth post cursor related to the data channel.

The output of the compare shift circuit 309 on connection 317 is referred to as “test data” and is supplied to a compare function 328. The output of the data shift circuit 316 on connection 318 is referred to as “shifted data” and is supplied to the compare function 328. The compare function 328 also receives a 16 bit compare mask over connection 326. The compare function 328 performs 20 parallel comparisons between two sets of symbol (two-bit) data from the compare shift circuit 309 and the data shift circuit 316. The compare function 328 is controlled by a 16 bit mask which determines which of the 16 possible patterns of the test data on connection 317 and shifted source data on connection 318 is valid. The compare function 328 can provide any of the 65536 (2̂16) possible logical functions for the four possible inputs, 2 bits from the test channel against 2 bits from the data channel. This allows for simple comparisons (exclusive OR) functions on either or both bits, as well as any other logical function. This selected data is then provided over connection 334 to error logic 338.

In this example, the compare function 328 is defined by the function:

output is equal to the bit of the mask on connection 326 equal to (symbol(317)*4)+symbol(318). The notation (symbol(317)*4+symbol(318) defines the mask bit number that defines the output as a one, where the bit position is equal to the symbol value on connection 317 times 4, plus the symbol value on connection 318. If the symbol value on connection 317 is a 3 and the symbol value on connection 318 is a 1, then the relevant bit number is 3*4+1=bit 13.

For this example, the compare mask on connection 326 is set to binary 0000100010000000, which means that the output of the compare function 328 is true when the symbol on connection 317 is either a 1 or a 2, and the symbol on connection 318 is a 3. Bit 7 of the mask on connection 326 refers to the signal on connection 317 equals 1 and the signal on connection 318 equals 3 (1*4+3). In this case, bit 7 is the relevant bit which is equal to the first symbol (on connection 317) being 1, and the second symbol (on connection 318) being 3, with the equation yielding 1*4+3=7. Bit 11 of the mask on connection 326 refers to the signal on connection 317 equals 2 and the signal on connection 318 equals 3 (2*4+3). In this case, bit 11 is the relevant bit which is equal to the first symbol (on connection 317) being 2 and the second symbol (on connection 318) being 3, with the equation yielding 2*4+3=11.

(3) 00000000000000100000 (334);
(4) 00010101000100000100 (334).

The qualification data path 320 comprises three stages of operation. The first qualification is performed by processing element 322, which comprises asynchronous logic and which receives the upper bits (37:16) of the pre-shifted source data values from the register 312 over connection 319 and a 64 bit mask over connection 321. The 64 bit mask allows the selection of specific patterns in the incoming data. For PAM 2, only 8 bits of the 64 bit mask are valid, so there is an 8 bit mask that selects from the 8 possible three bit sequences, 000, 001, 010, 011, 100, 101, 110 and 111 for PAM 2. For PAM 4, since there are two bits in each symbol, then there are 64 possible sequences of 3 symbols, {00, 00, 00}, {00, 00, 01}, {00, 00,10}, . . . {11,11,10}, {11,11,11}. The mask selects which of these sequences are considered valid. For example, there are times when it is desired to ignore certain sequences as they can interfere with the tuning algorithm. Or, it may be desirable to tune the receiver 200 based upon a specific sequence. For example, in PAM 2, it may be desirable to understand the issues related to a single signal transition that was preceded by two bits that were the same, so it may be desirable to only select the sequences 001 and 110 for receiver tuning. The operation of the processing element 322 allows for any of 64 possible combinations of three symbol sequences. Each bit in the 64 bit mask corresponds to a specific three symbol sequence. The output on connection 325 is a 20 bit value that qualifies which symbol positions are valid.

The processing element 322 is defined by the function: output is equal to the bit of the mask on connection 321 equal to (symbol(319)+(symbol(319) shifted right by 1)*4+(symbol(319) shifted right by 2)*16)). The data on connection 319 is equal to the data on connection 313 shifted to the right by 16 symbols. This operation is a fixed shift, and as such, it can be implemented without any circuitry, by connecting the desired parts of connection 313 to connection 319.

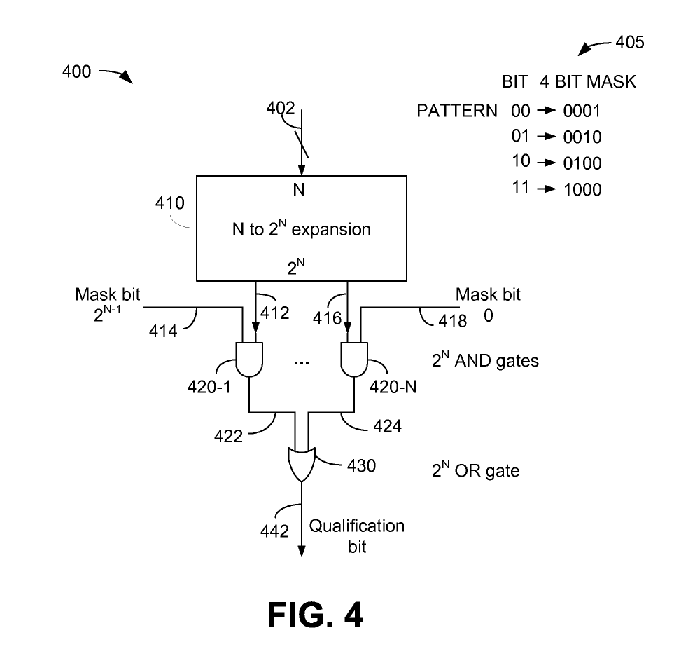

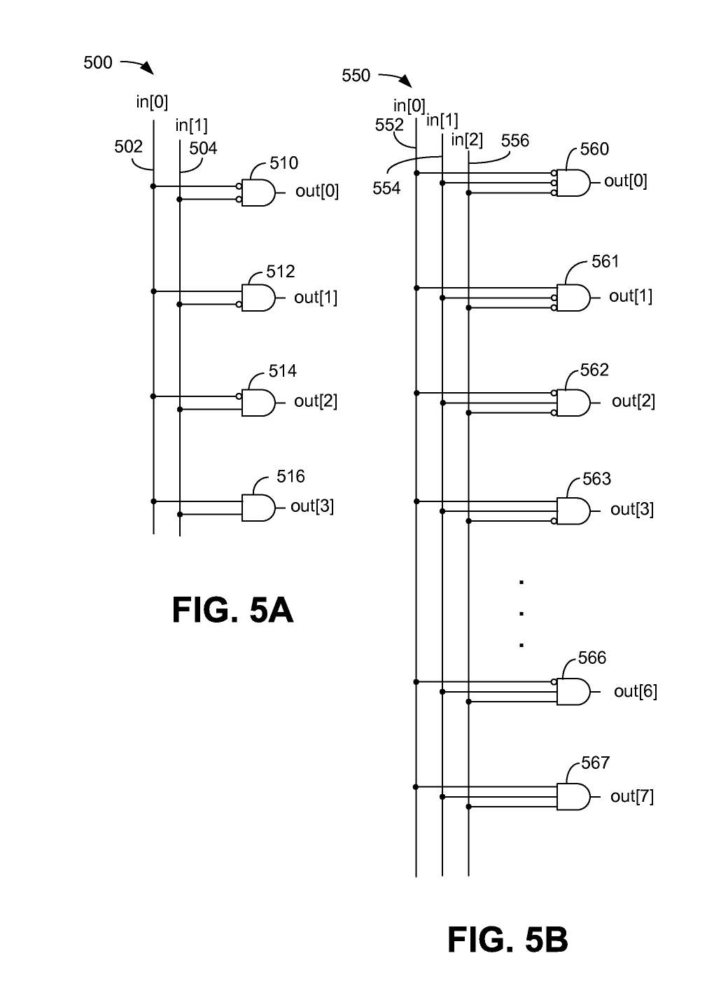

The data on connection 319 is equal to the data on connection 313 shifted to the right by 16 symbols, and where the rightmost 23 bits are used. The processing element 322 compares three consecutive symbols in connection 319 against a mask function that creates a true output when the mask value related to the specific sequence is set to true. The basic architecture for the processing element 322 (and the processing elements 328 and 332) is described below in FIGS. 4 and 5. The symbols 16, 17, and 18 of the connection 313 become symbols 0, 1, and 2 of the connection 319. These three symbols, with 2 bits for each symbol, comprise 6 total bits for a total of 64 possible combinations. The 64 bit mask on connection 321 determines which of these 64 possible combinations will provide a true bit on the output of processing element 322 onto connection 325.

For this example, the enable mask on connection 321 is equal to the hex value 0x0000f0f000000000. This sets bits 36, 37, 38, 39, 44, 45, 46, 47. The output of the processing element 322 is true when the first symbol of the three symbol sequence is any symbol, the second symbol is equal to 1 or 3, and the third symbol is equal to 2. So bit 0 of the connection 325 is affected by symbols 0, 1, and 2. Bit 1 of the connection 325 will be affected by symbols 2, 3, and 4. This is true until bit 19 which will be affected by symbols 19, 20, and 21.

(3) 2233011312110123101102 (319);
(4) 1302133211321201031022 (319).

The output on connection 325 is:

(3) 01000000010000100000 (325);
(4) 00010001000100000000 (325).

The second qualification is performed by processing element 332, which receives the shifted data values from the data shift circuit 316 over connection 323 and a 4 bit mask over connection 331. The 4 bit mask selects which of the four possible symbols (00, 01, 10, 11) are valid. The operation of the processing element 332 is done based upon the shifted source data and qualifies the shifted source data on connection 323 based on the possible data pattern. This is performed using a 4 bit mask that selects which of the 4 possible symbols are to be considered for comparison. The output on connection 336 is a 20 bit value that qualifies which symbol positions are valid.

The processing element 332 is defined by the function: output is equal to the bit position of the mask equal to the symbol value on the input from (323).

For this example, the control signal on connection 331 is set to 0010, which selects the symbol 1. The signal on connection 323 is the same pattern as the signal on connection 318:

(3) 01131211012310110210 (323);
(4) 13321132120103102233 (323).

The value on connection 336 is a one (1) when the symbol value on connection 323 is 1:

(3) 01101011010010110010 (336);
(4) 10001100100100100000 (336).

The third qualification is performed by the processing element 339, which receives the 20 bit value selecting the valid symbol positions from the processing element 322 over connection 325, the 20 bit value selecting the valid symbol positions from the processing element 332 on connection 336, and a 2×20 bit valid mask over connection 337. The third qualification is a 40 bit field (using the 2×20 bit valid mask) which allows qualification of the source data for specific bits within any 40 bit word width. Because only 20 bits are processed at a time, the ACE 246 sequences between two 20 bit fields that are synchronized back to the serial-to-parallel converter 234 (FIG. 2). This 40 bit field allows qualifications based on 8 bit groups so that appropriate 8 bit input can be provided to the FFE/DFE parallel block (212, FIG. 2) in the receiver. The output of the processing element 339 are the valid bit positions that are to be reviewed and analyzed, and are provided to a counter 346 over connection 341 and to the error generator 338 over connection 342. The output of the counter 346 is the valid count and is provide over connection 248 to the register element 256 (FIG. 2) via the CPU 252 (FIG. 2).

The control signal on connection 337 is set to either hex 0x0f0f0 or 0xf0f0f.

(3) 00001111000011110000 (337);
(4) 11110000111100001111 (337).

The processing element 339 is defined by the logical AND of the inputs (325), (336), and (337). The output of the processing element 339 on connection 341 is:

(3) 00000000000000100000 (341);
(4) 00000000000100000000 (341)

The error logic 338 combines (logically ANDs) the data on connection 334 with the “valid location” qualification bit on connection 341. In other words, the output of the compare function 328 on connection 334 is qualified with the valid symbol positions (from valid location processing element 339) by the error logic 338 to determine the final error word which is provided over connection 343 to an error counter 344.

The output of the error logic 338 on connection 343 is:

(3) 00000000000000100000 (343);
(4) 00000000000100000000 (343).

The value in error count logic 344 is the sum of all errors, the total of the bits on connection 343:

(3) 1 (248);
(4) 2 (248).

The value in the valid count logic 346 is the total of all of the bits on connection 341:

(3) 1 (248);
(4) 2 (248).

The ACE 246 can be configured to provide error inputs into a standard least mean squares (LMS) algorithm that a person having ordinary skill in the art can use to determine how the tap registers can be individually adjusted to improve the tuning of the FFE and the DFE to improve the working margin of the receiver 200.

FIG. 4 is a block diagram illustrating the basic logic used to implement the 4 bit, 16 bit and 64 bit mask functions described in FIG. 3. FIGS. 5A and 5B are examples of the expansion logic 410 of FIG. 4. In FIG. 3, there are a number of functions (322, 328 and 332) with variable width masks. The variable width masks select which of a number of possible combinations of bits are allowed. The logic 400 illustrated in FIG. 4 shows how these functions can be implemented. The logic 410 comprises a demultiplexer that generates a one-hot pattern 2̂n bits long from an “n” bit input. A 1 bit value on connection 402 will generate the two possible outputs on connections 412 and 416 based upon one input bit. An input of 0 on connection 402 will yield an output of 01, comprising a 0 on connection 412 and a 1 on connection 416. An input of 1 on connection 402 will yield an output of 10, comprising a 1 on connection 412 and a 0 on connection 416. As shown in the logic 500 of FIG. 5A, a two bit input on connections 502 and 504 has the following truth table when processed by the AND gates 510, 512, 514 and 516:

00->0001
01->0010
10->0100
11->1000

The term “one-hot” refers to a digital word or vector where there is a single bit that is at a one (true) logical level and all other bits are at a zero (false) logical level.

A three bit version, as shown in the logic 550 of FIG. 5B, where a three bit input on connections 552, 554 and 556 has the following truth table when processed by the AND gates 560 through 567:

000->00000001
001->00000010
010->00000100
011->00001000
100->00010000
101->00100000
110->01000000
111->10000000

Another way to describe this is that for an output word out[(2̂n−1):0], out[n]=1 when n==(is equal to) input, and out[n]=0 when n !=(is not equal to) input. The logic in 410 is used to expand the input from n bits to 2̂n bits, then the masking function provided by the AND gates 420-1 through 420-N and the OR gate 430 collapses the expanded 2̂n bits back to a single qualification bit on connection 442.

For example, if two bits are provided over connection 402 to the logic 410, the two bits represent four possible states, 00, 01, 10, and 11. In this example, a four bit mask 405 can be used to select which of the four states create a one on the output on connection 442.

In this example, the mask corresponding to the input bits “11” is “1000,” which will yield a logic “1” through the AND gates 420-1 through 420-N if the input is 11. Inputs of 00, 01 and 10 will produce a logic “0” output of the AND gates 420-1 through 420-N. This mask of “1000” creates the logical AND function.

A mask “0110” will yield a logic “1” out of the OR gate 430 if the input is either 10 or 01, which creates an exclusive OR (XOR) function.

A mask “0000” will always yield a zero out.

These examples of simple logical functions can be expanded to show that all 16 possible functions of two bits can be created with a four bit mask.

This concept can be expanded to more than two input bits. For example, three input bits, as shown in FIG. 5B, use an 8 bit mask to create any logical function.

This disclosure describes the invention in detail using illustrative embodiments. However, it is to be understood that the invention defined by the appended claims is not limited to the precise embodiments described.

What is claimed is:

1. A correlation engine, comprising:
a first register configured to receive a test data signal;
a second register configured to receive a main data signal;
first shift logic configured to shift the test data signal by a predetermined value between 0 and 3 symbols;
second shift logic configured to shift the main data signal by a predetermined value between 0 and 20 symbols; and
comparison logic configured to compare the shifted test data signal and the shifted main data signal to generate an error signal.

2. The correlation engine of claim 1, further comprising error logic configured to qualify the error signal with a valid symbol location.

3. The correlation engine of claim 2, further comprising qualification logic configured to determine a selected position relating to the test data signal and the main data signal, the selected position corresponding to the valid symbol location.

4. The correlation engine of claim 1, wherein the test data signal is shifted by an amount different than the main data signal is shifted, such that there is a difference in alignment between the test data signal and the main data signal, thus allowing a receiver to collect error data from the test data signal based on the difference in the alignment between the test data signal and the main data signal.

5. The correlation engine of claim 4, wherein the test data signal comprises a degraded version of the main data signal, the test data signal created by an amplifier configured to receive an offset voltage configured to cause the amplifier to be error prone, thus causing the test data signal to be more error prone than the main data signal.

6. The correlation engine of claim 5, wherein causing the test data signal to be more error prone than the main data signal allows the receiver to be tuned with the main data signal by comparing the differences between the test data signal and the main data signal.

7. The correlation engine of claim 6, wherein the test data signal is degraded in any of time and phase.

8. A method for processing a signal in an automatic correlation engine (ACE), comprising:
receiving a test data signal;
receiving a main data signal;
shifting the test data signal by a predetermined value between 0 and 3 symbols;
shifting the main data signal by a predetermined value between 0 and 20 symbols; and
comparing the shifted test data signal and the shifted main data signal to generate an error signal.

9. The method of claim 8, further comprising qualifying the error signal with a valid symbol location.

10. The method of claim 9, further comprising determining a selected position relating to the test data signal and the main data signal, the selected position corresponding to the valid symbol location.

11. The method of claim 8, wherein the test data signal is shifted by an amount different than the main data signal is shifted, such that there is a difference in alignment between the test data signal and the main data signal thus allowing a receiver to collect error data from the test data signal based on the difference in the alignment between the test data signal and the main data signal.

12. The method of claim 11, wherein the test data signal comprises a degraded version of the main data signal, the test data signal created by an amplifier configured to receive an offset voltage configured to cause the amplifier to be error prone, thus causing the test data signal to be more error prone than the main data signal.

13. The method of claim 12, wherein causing the test data signal to be more error prone than the main data signal allows the receiver to be tuned with the main data signal by comparing the differences between the test data signal and the main data signal.

14. The method of claim 13, wherein the test data signal is degraded in any of time and phase.

15. A receiver system, comprising:
a linear equalizer configured to develop an input signal for a pipelined processing system;
a regenerative sense amplifier configured to receive an offset voltage and configured to generate an error prone test data signal;
a first register configured to receive the test data signal;
a second register configured to receive a main data signal;
first shift logic configured to shift the test data signal by a predetermined value between 0 and 3 symbols;
second shift logic configured to shift the main data signal by a predetermined value between 0 and 20 symbols; and
comparison logic configured to compare the shifted test data signal and the shifted main data signal to generate an error signal.

16. The receiver system of claim 15, further comprising error logic configured to qualify the error signal with a valid symbol location.

17. The receiver system of claim 16, further comprising qualification logic configured to determine a selected position relating to the test data signal and the main data signal, the selected position corresponding to the valid symbol location.

18. The receiver system of claim 15, wherein the test data signal is shifted by an amount different than the main data signal is shifted, such that there is a difference in alignment between the test data signal and the main data signal, thus allowing a receiver to collect error data from the test data signal based on the difference in the alignment between the test data signal and the main data signal.

19. The receiver system of claim 18, wherein the test data signal comprises a degraded version of the main data signal, thus causing the test data signal to be more error prone than the main data signal.

20. The receiver system of claim 19, wherein causing the test data signal to be more error prone than the main data signal allows the receiver to be tuned with the main data signal by comparing the differences between the test data signal and the main data signal.
